(19) United States
(12) Patent Application Publication
(10) Pub. No.: US 2004/0158360 A1
(43) Pub. Date: Aug. 12, 2004

(54) System and method of energy management and allocation within an energy grid

(76) Inventors: Charles Garland II, New York, NY (US); Neil J. Skidell, New York, NY (US)

Correspondence Address: John M. Johnson, Carter Ledyard & Milburn LLP, 2 Wall Street, New York, NY, 10005, US

(21) Appl. No.: 10/772,723

(22) Filed: Feb. 4, 2004

Related U.S. Application Data
(60) Provisional application No. 60/444,844, filed on Feb. 4, 2003.

(51) Int. Cl. G06F 17/00

(52) U.S. Cl. 700/286; 705/412

(57) ABSTRACT

A system and method for the allocation of energy services within an energy grid comprising a plurality of mobile, selectively actuable energy generating units each connected to the energy grid; a database populated with operating condition variables for each of the mobile energy generating units, actuation of each of the energy generating units based on the operating condition variables; data inputs for receiving actual operating conditions associated with each of the energy generating units; and a processor for analyzing the actual operating conditions and the operating condition variables to actuate each of the energy generating units when the actual operating conditions have a predetermined value as provided by the operating condition variables, wherein each of the mobile energy generating units has an operation cost based on predetermined factors, at least one alternative energy generating source has an operation cost also based on the predetermined factors, the processor calculating the operation cost for at least one mobile energy generating unit and for the at least one alternative energy generating source, the processor only actuating the at least one energy generating unit when its operating cost is less than the operating cost of the at least one alternative energy source.

This application claims the benefit of U.S. Provisional Patent Application Serial No. 60/444,844, filed Feb. 4, 2003.

### BACKGROUND OF THE INVENTION

The present invention relates to energy grids, and more particularly to the distribution, and modification of distribution, of energy therein.

U.S. Published patent application No. 2003/0030279 A1 discloses a portable power module trailerable over public roads and capable of providing at least approximately one megawatt of electrical power. In one embodiment, the portable power module includes a gaseous fuel motor drivably connected to an electrical generator. The motor includes a combustion chamber and a coolant jacket positioned adjacent to the combustion chamber. A radiator is connected in flow communication with the coolant jacket and an exhaust gas silencer is connected in flow communication with the combustion chamber. In one aspect of this embodiment, the portable power module further includes a container in which the motor, the generator, the radiator, and the exhaust gas silencer are installed when the portable power module is in a normal operating configuration. In one embodiment, the container has the dimensions of a standard shipping container, such as a standard 40-foot ISO shipping container. The power module disclosed herein is not contemplated to be used in a deployment scenario for integration in a utility grid.

U.S. Published patent application No. 2002/0190525 A1 discloses a distributed generating system is disclosed that is capable of conditioning power from a utility grid, providing backup power in the event the utility grid fails, and exporting excess power to the utility grid. The system comprises an engine coupled to an asynchronous generator, an energy storage device, and engine controller capable of managing the engine and controlling its torque or speed or power, and an inverter for generating an AC output and also capable of controlling the frequency and voltage of the generator to match the frequency of a coupled utility grid. This patent application merely discloses a system for local loads.

U.S. Pat. No. 6,532,398 B2 discloses an automatic lift-type power generation unit within an automatic lift-type mobile facility that is adapted to be loaded onto the rear of a carrying vehicle. The power generator unit includes a power generation section which is a component of said mobile facility, supplies electric power by generating said power, and includes cubicle, prime mover equipment, and electric power equipment. The power generator unit also includes an automatic lifting-and-lowering section which includes chassis, outriggers, jacks, universal casters, and a remote controller.

U.S. Pat. No. 6,388,869 B1 teaches a power generator unit that includes a container having a peripheral wall enclosing a power generating motor assembly. A breaker box is provided in an opening in the peripheral wall of the container, so as to have power outlet socket connectors accessible from outside of the container. An external electric circuit to be fed with electricity can be operatively connected to the power outlet socket connectors. Power inlet socket connectors are also provided in the breaker box, accessible from inside the container, to which the power generating motor assembly can be operatively and releasably connected. A breaker links the power inlet socket connectors to the power outlet socket connectors, to open the breaker box circuit should any excessive power demand occur. The breaker box is releasably bolted to the peripheral wall of the container, about the opening in which it is inserted. A pair of spaced-apart pockets are provided on the breaker box casing, being outwardly opened. Forks of a forklift truck can engage these pockets, to hold and carry the breaker box when removal or installation of the breaker box occurs.

U.S. Pat. No. 4,469,954 relates to a movable substation which comprises a removable truck frame, substation equipment carried on the frame, a generator having a prime mover coupled therewith for supplying electric power to the substation equipment for the starting thereof, and a relay unit for detecting whether or not said substation equipment has started to supply electric power to a load. The relay unit connects the generator to the substation equipment when electric power is not supplied from the substation equipment to the load, and disconnecting the generator from the substation equipment when the electric power can be supplied from the substation equipment to the load.

U.S. Pat. No. 5,754,033 discloses a system for providing electrical-power to remote communities widely distributed over an extended geographical area includes a generating station located proximate each of the communities, each generating station supplying only that community to which it is proximate. The generating stations are in electronic communication with a central computer. Each generating station includes a plurality of generators. Each of the generators is controlled by a microprocessor based controller. Each controller is arranged to operate the generating station cooperatively with the other controllers associated with other generators in the station, and to assume a supervisory role in doing so by a mutual arbitration procedure among the controllers. Each controller is also arranged to monitor important generator operating parameters and to communicate these parameters to the central computer. Any controller may be reprogrammed by instructions communicated from the central computer, and functions of any controller may be overridden by instructions communicated from the central computer. The controllers include novel signal processing circuits and logic for improved voltage and frequency regulation. The controllers also include novel circuits and logic for monitoring generator fuel consumption and calculating generator fuel-efficiency therefrom. Thus, this patent merely discloses a method for remote monitoring and control.

U.S. Pat. No. 5,680,324 includes a communications processor having an electronic network system which includes a total of 17 individual ports, four quad universal asynchronous receiver/transmitter devices, each of which serves four separate ports, and a microprocessor which processes and controls the flow of data under the control of stored control programs, command settings and command logic. Connected to a plurality of those ports, referred to as IED ports, are intelligent electronic devices (IEDS), such as protective relays or meters. Connected to other ports, referred to as master ports, are remote terminal units, or a local computer or terminal, or a modem which can be connected to an external telephone line. The apparatus includes both buffer and long-term storage for development of a database, as well as an IRIG-B capability for synchronization of the time clocks of the connected devices. This patent focuses on data management technology and a method for remote monitoring and control.

U.S. Pat. No. 5,406,495 teaches a monitoring and control system that provides a distributed intelligence, data acquisition and control system which collects and analyzes large amounts of data representing power usage from a power distribution substation. Using a Discrete Fourier Transform, the system provides accurate tracking of the primary frequency of the voltage and current waveforms in the power equipment, and determines the relative phase between the voltage and current waveforms. The system provides real time monitoring of power usage and real time control of various functions in the substation.

U.S. Pat. No. 5,179,376 discloses a monitoring and control system that provides a distributed intelligence, data acquisition and control system which collects and analyzes large amounts of data representing power usage from a power distribution substation. The system also provides the capability of various control functions for the substation. The system provides communications capabilities between local devices and also with a remote computer. The system provides real time monitoring of power usage and real time control of various functions in the substation. This patent discloses a system to be used with substations, not with generation.

U.S. Published patent application No. 2002/0138176 A1 provides, generating equipment located within power users' facilities, including emergency generators, is dispatched to reduce the power requirements of their respective facilities, which are served by the external electric generation, transmission and distribution systems. Dispatch is initiated by the main V-GEN Server when the conditions for initiating deployment are favorable. Such conditions might be a procurement action by a utility or an ISO seeking reserves, market conditions, or physical conditions in the transmission and distribution systems. When such conditions prevail, the main V-GEN Server deploys a signal to the regional V-GEN Hub whose location is appropriate for response (different sections of transmission and distribution systems are usually under varying degrees of utilization and therefore stress, so congestion will typically occur only in certain portions of a transmission and distribution system). The signal is routed via the internet to the local V-GEN Hub.

The technique can utilize a field-installed or factory-installed, proprietary, application-specific V-GEN Control Panel on the generator(s) within each customer's facility. The V-GEN panel typically includes an input/output networkable controller. In one embodiment, the controller has firmware programmed to specifically carry out optimized sequences, either predetermined or determined in real-time, to energize generators in response to a deployment signal from the central V-GEN Server through the local V-GEN Hub. These controllers have about 8 inputs and about 8 outputs on board. The inputs are preferably analog. The inputs accept a signal that is about 0 to about 5 vdc or about 4 to about 20 ma. The outputs are preferably analog outputs of from about 0 to about 12 vdc. The signal input and analog outputs are industry standards and they are generally compatible with most third party transmitters and controls devices. The panel has a common protocol allowing it to communicate with other controllers to carry out complicated sequences of demand reduction.

In an exemplary application, when the deployment signal is received by the local V-GEN Hub, the V-GEN Hub dispatches a signal via the local phone system to the various V-GEN Control Panels. Each V-GEN Control Panel preferably sends a start signal to the respective generator. The generator is preferably started per the manufacturer's start sequence. The start sequence preferably includes the actuation of the auto transfer switch (ATS), which disables the utility-provided power in favor of the generator-provided power. This is preferably accomplished in such a way that there is no interruption of electric service to the facility. The sequence of the start-up of the generator and the transfer switch is a generator manufacturer-provided control sequence, initiated and maintained by the original equipment manufacturer's proprietary controller. The V-GEN Control Panel sends a start signal to the OEM controller on the generator. The V-GEN panel monitors the output of the generator to calculate the real time load on the generator thus the real time load reduction in the external generation, transmission, and distribution systems. This information is transmitted to the V-GEN Hub and V-GEN Server. The V-GEN Hub and Server monitor the conditions for deployment and the performance of the V-GEN resources constantly, continually optimizing the deployment in response to changing conditions.

In procuring reserves, transmission system operators generally procure reserves in fixed amounts, corresponding to the fact that generators have fixed output capacities under specified environmental conditions. In a preferred embodiment, the present invention will preferably dispatch generating assets in response to load conditions within a facility as well as in the generation, transmission, and distribution systems. Since the conditions within the facility may vary, the output of the resources deployed by the invention may also vary.

Procuring reserves, as described above, will generally have two ramifications. First, real-time variance in conditions within a facility will, to some extent, track variance in conditions in the local distribution system. For example, if a city block falls under a cloud, the load on all the air conditioning systems in that block will be reduced, and the electric demand on the distribution system in that block will be reduced. Thus, a rough correspondence will exist between the micro-deployment of generating assets and the micro-grid conditions. Moreover, throughout the V-GEN system, the V-GEN Server will control the aggregation and dispatch of generating assets to ensure that the obligations of the user of the invention to provide committed reserves are met.

In a preferred example, the V-GEN Server and Hub are hotlinked to the computers which control the external transmission and distribution systems to accommodate real-time micro- and macro-variance in reserve requirements. In a further preferred example, the hotlink is accomplished by using OPC {OLE [Object Linking and Imbedding]Process Control}.

The use of the local V-GEN Hub as an intermediary in the communication link between the V-GEN Server and the V-GEN Control Panel enables the internet interface to be regional and the local communications to use other forms of high-speed communication, such as telephone or 2-way radio. This in turn enables the V-GEN Control Panel to have an inexpensive communication device, rather than an internet-capable computer. In addition to the internet backbone, the present invention can use substantially any form of rapid communication, including, for example, telephone, radio or satellite based communication techniques. This invention is reactive, not proactive technology, and can not be employed for long duration run times in a mobile environment.

U.S. Published patent application No. 2002/0120368 A1 teaches an energy management network that includes remote distributed energy generation elements, and/or network connected multi element generation groups, and/or network connected energy generation elements. Energy generating elements are turbogenerators. An energy management network includes one or more Energy Network (EnerNet) Controllers for the purpose of controlling and/or monitoring a network of energy generation units, which work separately or in coordinated activities. This technology focuses on generation/compression units and controls local banks of generators to behave as a unit.

U.S. Pat. No. 6,219,623 B1 protects against island situations with one or multiple power sources connected to an electric distribution grid. The method and apparatus detects variations in the voltage and frequency of the grid. An observed change in grid voltage causes a change in output power that is sufficient to cause an even larger change in grid voltage when the utility AC power source is disconnected. An observed change in grid frequency causes a change in phase or reactive output power that is sufficient to cause an even larger change in grid frequency. If several shifts in voltage or frequency happen in the same direction, the response to the change is increased in an accelerating manner.

U.S. Pat. No. 6,002,260 teaches a fault sensor suitable for use in a heterogenous power distribution system that executes a stored program and causes sufficient information to be collected to distinguish a source of fault current as being from a public utility portion of the power distribution network or from a distributed generator. Short circuit current and magnetizing current are reliably distinguished based on differences in VI “signatures.” In addition, the fault sensor periodically senses a condition of a battery of the fault sensor. When the condition of the battery indicates the battery power if low, the fault sensor sends a digital data signal including a low battery indication to a remote location. Subsequent to occurrence of a sustained power outage, the sensor detects that power has been restored and sends to a remote location a digital data signal including an indication that power has been restored. The sensor periodically measures peak line voltage and peak line current and reports peak values to the remote location. This patent discloses technology that merely detects and identifies sources of power quality problems.

U.S. Pat. No. 5,760,492 discloses a control system for a power transmission and distribution system having a plurality of distributed power supplying and receiving units, each of which include a control unit and are connected along a power distribution line. The power supplying and receiving unit function to generate active and reactive powers of fundamental and higher harmonic waves to supply and receive the same to and from the power distribution line. A first central control unit controls the power distribution line and is designed to store information relating to the configuration of the power distribution line, to collect information with regard to instant open and close conditions of respective disconnecting switches connected for sectioning the power distribution line, and with regard to current electrical quantities on the power distribution line. Individual control command signals specific to the respective power supplying and receiving units are produced based on the stored and collected information and the respective power supplying and receiving units are controlled so that a desired target condition of the power distribution line is achieved autonomously within the power distribution line through an optimum cooperation control of the units.

### SUMMARY OF THE INVENTION

The subject invention employs mobile energy generating units (SCAMPS, herein), which are intended to be deployed through distribution utility companies' (DUC, herein) assets (interconnected on the utility side of the energy user's meter), and at the distribution level of the T&D system (circumventing the transmission level). The modules and other SCAMPS-related assets are intended to be owned and operated by a third-party power producing entity (NES, herein), other than the distribution utility company (DUC), but planned and coordinated with the utility company's direct collaboration. This third party company provides energy services to the utility company (and/or directly to its industrial customers) by way of a special contractual instrument called an ECDA (energy capacity and delivery agreement), which is significantly different than, but in place of, a typical PPA (power purchase agreement).

Planning and coordination of the system and method of the present invention involves analytical methods associated with determining the optimal siting of each mobile energy generating unit. Included are several variables, such as corresponding generator size, engine type, deployment and dispatch timing, fuel type, and pricing, for a fleet of mobile units that are to be used within a utility company's territory, for example.

The selection of the specific set of hard assets (generators, engines, switch gear, interconnection equipment, remote monitoring and control equipment, metering, emissions control, for example) is to be optimized for each specific application within a given utility company's business, regulatory, and technology environment.

The mobile energy generating units as well as other SCAMPS-related assets will be controlled by a software application called the deployment and dispatch algorithm (DDA). This DDA will be integrated with various aspects of each distribution utility company's (DUC) internal software systems, including their SCADA (supervisory control and data acquisition) systems and their customer databases, which contain vital data about load profiles throughout the distribution system. While integration with these systems will take place on a customized, case-by-case basis, the integration procedure will be facilitated by the initial design and development of a SCAMPS-specific application programming interface, which will accelerate the coding and attributes selection processes. The overall interaction of SCAMPS mobile energy generating units and related assets with all elements of the DUC will be by way of the DDA.

The subject invention utilizes real-time monitoring, alarming, and control systems (software and hardware) that will facilitate remote operation of the SCAMPS mobile energy generating units.

The subject invention can employ pre-existing mobile energy generating units that are then retro-fitted with the necessary sensors and connection components in order to function as part of the system and method of the present invention.

### BRIEF DESCRIPTION OF THE DRAWINGS

The invention, and its method of operation, together with additional objects and advantages thereof, can be better understood by reference to the following detailed description considered in connection with the accompanying drawings wherein:

FIG. 1 is a block diagram of an overview of the system and method of the present invention illustrating the energy capacity and delivery agreement data parameters, the substantially real-time data acquisition components and the deployment and dispatch algorithm;

FIG. 2 is a schematic diagram showing an exemplary energy grid and deployment of the mobile energy generating units of the system and method of the subject invention therein;

FIG. 3 is a schematic diagram showing the electronic, computer, mechanical and electromechanical components of the system and method of the subject invention;

FIG. 4 is a logic flow chart of the process for the determination of the data parameters and ranges of the energy capacity and delivery agreement of the system and method of the subject invention;

FIG. 5. is a logic flow chart of the deployment and dispatch algorithm of the system and method of the present invention in the environment of base load or peaking power;

FIG. 6 is a logic flow chart of the deployment and dispatch algorithm of the system and method of the present invention in the environment of voltage support;

FIG. 7 is a logic flow chart of the deployment and dispatch algorithm of the system and method of the present invention in the environment of terrorism risk management; and

FIG. 8 is a logic flow chart of the deployment and dispatch algorithm of the system and method of the present invention in the environment of “blackout” mitigation.

### DETAILED DESCRIPTION OF THE PREFERRED EMBODIMENTS

1. System Overview

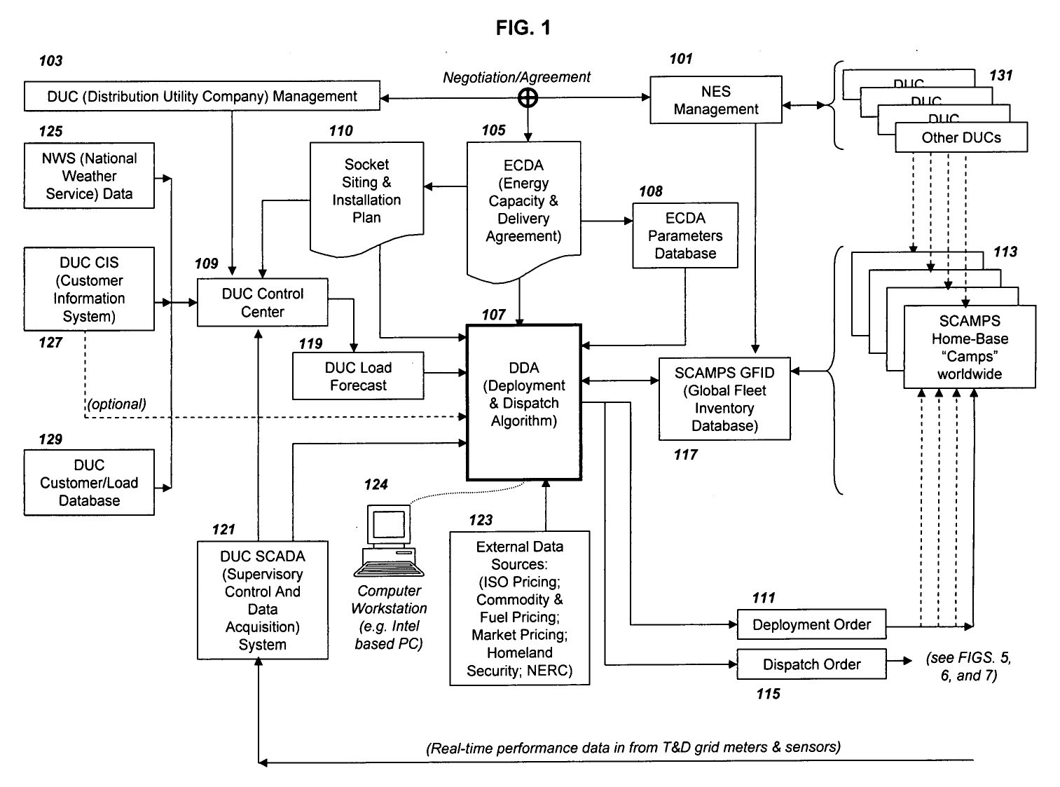

Referring to FIG. 1, the owner/manager of the SCAMPS mobile energy generating units and related assets 101 (NES, herein) and the distribution utility company (DUC) 103 agree on terms and conditions for the provision of SCAMPS mobile energy generating unit services to specific points within their electric distribution grid. These terms are documented within the Energy Capacity and Delivery Agreement (ECDA, herein) 105, whose key variables are ultimately input into the Deployment and Dispatch Algorithm (DDA) 107 through the ECDA parameters database 108. The DUC 103 directs its control center operations 109 to issue, through the DDA 107 and in conjunction with the data from the database of socket siting and installation plan 110, the specific deployment orders 111 to the local inventory of the SCAMPS mobile energy generating units sited and connected at the default home-base camp 113 specific to this DUC 103. The deployment order 111 is a process that begins with the disconnection of one or more specific mobile energy generating units at its existing location, and ends with the interconnection of the same mobile energy generating unit(s) at the desired utility node (location) specified in the deployment order 111. The DDA 107 also issues dispatch orders 115 to the deployed mobile energy generating units, once interconnected within the DUC grid. The dispatch order 115 is the process that begins with the powering-up of the mobile energy generating units(s), and their continued operation and service provision for the period of time designated in the order. The DDA 107 calculates the cost of deployment and dispatch of each of the appropriate and available mobile energy generating units(s) existing in the SCAMPS Global Fleet Inventory Database (GFID) 117, and prioritizes them by their optimal cost/other attributes. Depending on the status and effects of the deployment and dispatch orders, the DDA 107 also updates the GFID 117 appropriately. Computer workstation 124 is the computer platform (for example an Intel-based workstation, running Windows or other professional grade operating system) which hosts the DDA software 107 and related applications, programs and databases.

The DUC control center 109 creates a load forecast 119, which is another input into the DDA 107. The DDA 107 also incorporates real-time grid operation performance data from the DUC's Supervisory Control And Data Acquisition (SCADA) system 121, as well as various sources of economic and/or market data 123, including ISO (independent system operator) and/or RTO (regional transmission organization) market power/services pricing, fuel commodity pricing, and other market pricing data. As a means of providing the load forecast, and other interactions/inputs to the DDA 107, the DUC control center 109 incorporates data feeds, either in batch or in real-time mode, from the National Weather Service (NWS) weather forecast 125, the DUC's Customer Information System (CIS) metering data 127, and the DUC's Customer/Load Database 129. Alternately (as agreed upon by the particular DUC), the DDA 107 can accept input from any or all of these independent of the DUC control center 109.

NES 101 also simultaneously, or in the future, negotiates similar ECDA agreements 105 with multiple DUC entities 131, worldwide. Like the initial DUC 103 and resultant DDA 107, additional DDAs will be developed for each additional DUC that becomes “SCAMPS-enabled.” Each SCAMPS-enabled DUC will have a corresponding local home-base camp 113 assigned to it, and the inventory data from the total set of home-base camps is fed into, and aggregated by, the GFID 117.

2. Mobile Unit Deployment

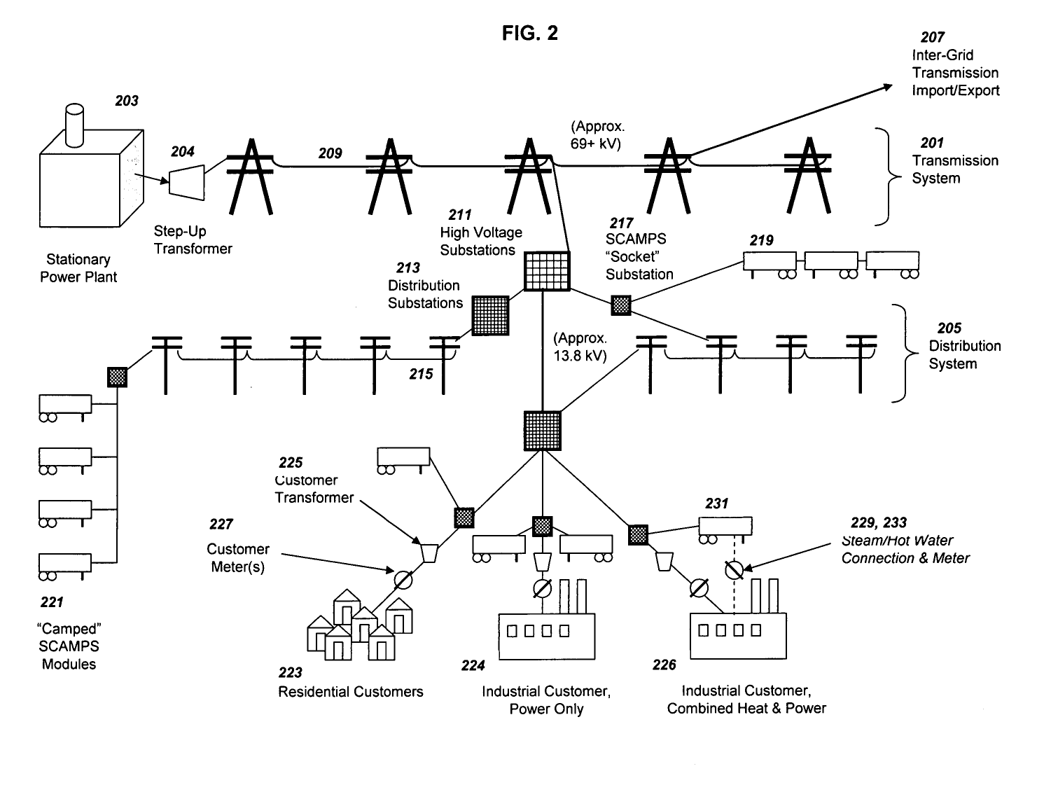

Referring to FIG. 2, the utility company's transmission system 201 connects various stationary power plants 203 to major power consumption nodes, which may include segments of the distribution system 205 or other transmission systems (e.g. in other regions) 207. Step up transformer 204 increases the generation voltage up to the appropriate system voltage. Transmission lines 209 interconnect with lower-voltage distribution systems by way of high-voltage substations 211, through lower-voltage distribution substations 213, which either distribute power in a one-to-many format, or step the voltage level down, or both, into lower-voltage distribution lines 215. Anywhere along those lines, but most likely at any one of several types of strategically-appropriate interconnection “nodes,” will be located a substation 217, into which one (or more “daisy-chained”) SCAMPS mobile energy generating units 219 can be “plugged” or interconnected into the grid. The mobile energy generating units 219 can be plugged into the grid at existing utility substations, at “home-base camp” sites 221, at utility customer sites 223, 224 and 226, or at any number of other strategically desirable nodes within the grid, per the DUC's choosing. The mobile energy generating units 219 can be deployed, or re-deployed, between or among any number of locations within the grid, or within other grids. At customer sites, the mobile energy generating units 219 will be interconnected at points above (on the higher-voltage side) of both the customer transformer 225 (which reduces the voltage to the appropriate customer-usable levels) and the customer meter 227. Again, one or more mobile energy generating units 219 can be plugged in at these sites, depending on the optimal capacity (or other services) desired at each node, and where appropriate, additional non-electric services such as steam, heat, and/or hot water 229 connections can be delivered by a cogeneration-enabled SCAMPS mobile energy generating unit 231 directly to the customer, through a separate non-utility company meter 233 (owned by and billed through the module owner/operator). The mobile energy generating units 219 can be, for example, commercially available energy generating units, retro-fitted, if needed, to function based on the needs and demands of the particular embodiment of the subject invention practiced.

3. System Hardware

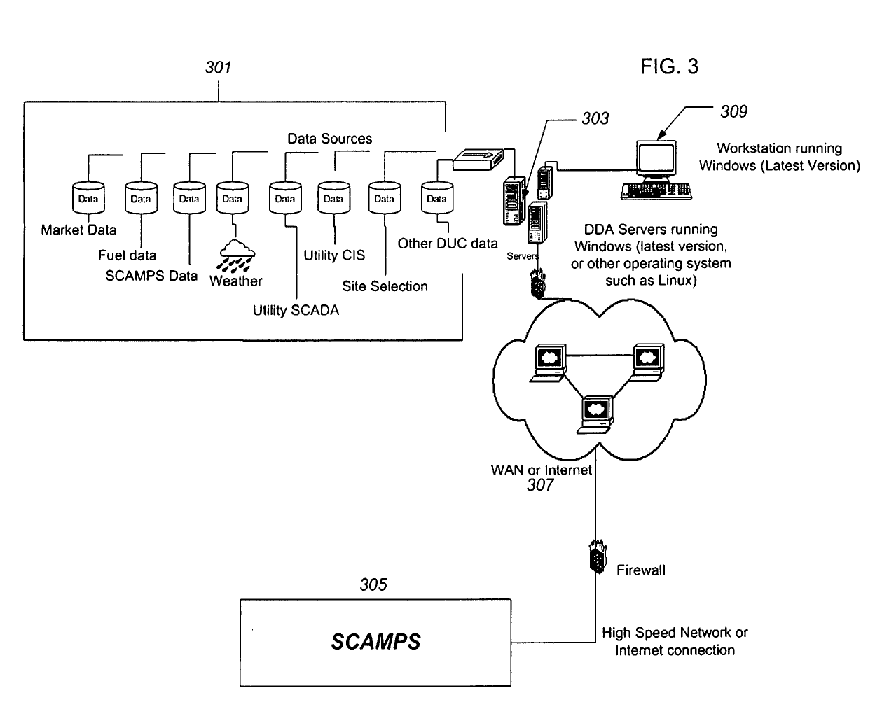

Referring next to FIGS. 1 and 3, the electronic, computer, mechanical and electromechanical components of the system and method of the present invention are shown and described. External data inputs 301, described further below, collect and process the external data necessary for implementation of the system and method of the subject invention, and are in electronic communication with DDA servers 303, also described further below. External data inputs 301 can provide substantially real-time data acquisition to DDA servers 303. The external data inputs 301 to the deployment and dispatch algorithm (DDA) servers 303 include: Weather data obtained from a commercially available source such as the national weather service or in some cases from privately owned weather stations that may consist of temperature sensors, humidity sensors, rain gauges, wind measurement devices. DUC SCADA data 121 obtained from the DUC 103 and gathered by the DUC 103 from electricity demand measurement devices, electricity consumption measurement devices, power quality measurement devices, temperature sensors sensing ambient conditions, temperature sensors embedded in electrical equipment such as transformers and substations, transmission and distribution line load flow data as derived from point/point demand and consumption measurements. Data obtained from the DUC's CIS (customer information system) 127 and generally consisting of customer electric meter reading data, customer orders for expanded service, customer orders for new service, and customer satisfaction metrics such as power quality and failure rate. Site selection data as determined by the DUC Market data relating to the real time, day-ahead and contract pricing for the products necessary to provide service to the DUC's customers, such data is either calculated internally by the DUC or is obtained from public sources such as the NYISO (New York independent system operator). Fuel data such as market pricing and trends, availability, specifications of the delivered product, as obtained from sources regularly engaged in the supply and/or trading of fuels such as natural gas, propane, various diesel blends, kerosene. From time to time the DUC will have additional, usually proprietary, data that must be utilized by the DDA 107 this data will be input from secure servers, controlled by the DUC 103, as required to ensure proper functionality of the DDA 107. Data provided by the SCAMPS GFID inventory database 117 as required to enable the DDA 107 to properly recommend deployment and dispatch of the SCAMPS modules in a particular DUC's territory; Additionally data will be obtained from both public & private, secure and not secure government or oversight agency databases to be utilized by the DDA 107.

The internal, or SCAMPS mobile energy generating units provided, data inputs 305 to the DDA servers 303 are provided via secure WAN or Internet connection 307. Data includes: Module operational status and real-time performance parameters such as engine temperatures, current and power output levels, as provided by an enpower, generator power controller as manufactured by Encorp (or equivalent). Additional data is provided by an enpower utility power controller as manufactured by Encorp (or equivalent). A camera, or cameras, Linksys (or equivalent) feed real time video images of the SCAMPS mobile energy generating unit site. A weather station consisting of a thermometer, humidistat, rain gage, and wind measurement apparatus feeding real time weather data.

The DDA servers 303, can be, for example, servers manufactured by Dell, IBM, SUN or equivalent (running Microsoft Windows Server (latest edition),Linux, or equivalent) and collect and process all data as required and as dictated by the various databases, algorithms and sub-routines. Access to the server data and generated output is provided via IBM workstations 309 running the latest edition of Microsoft Windows and through the use of an HMI (Human-Machine-Interface) such as Wonderware, when required.

4. Mobile Unit Site Selection

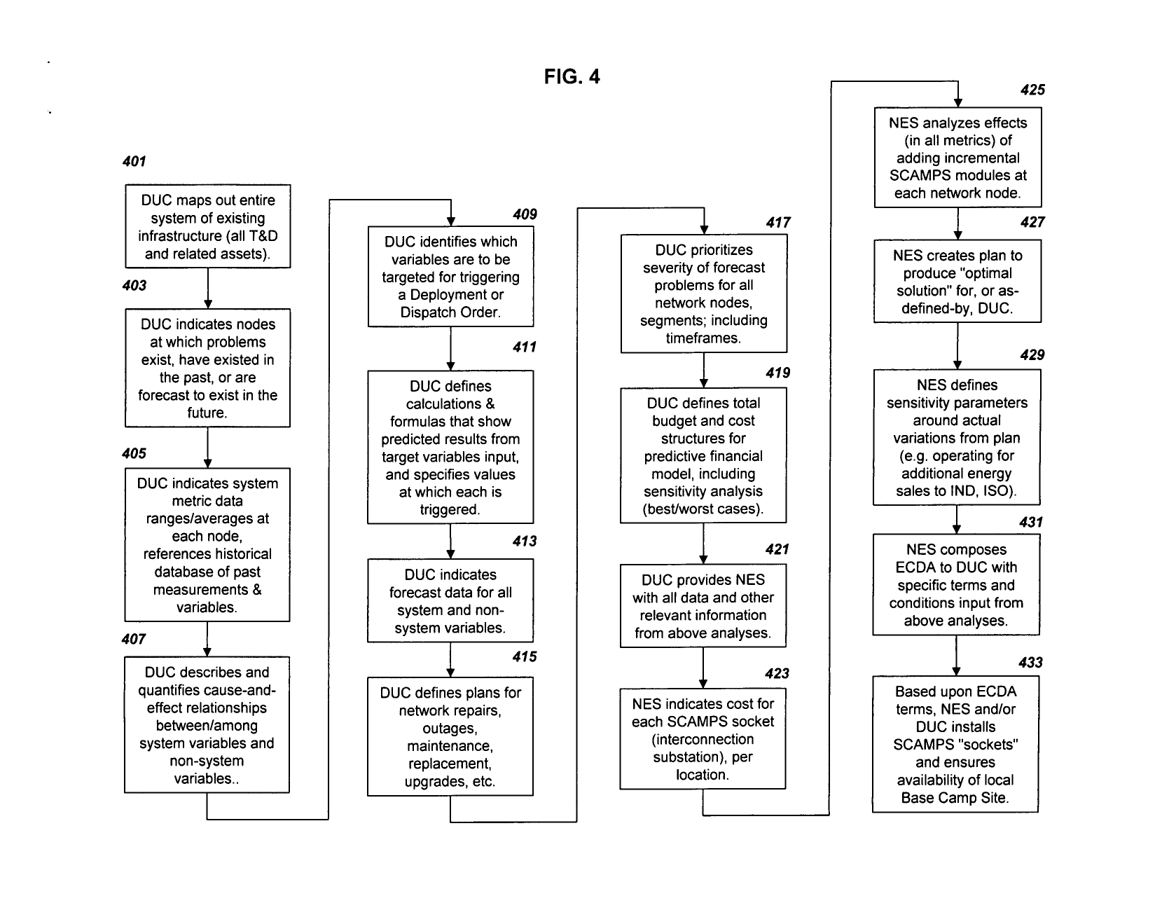

Referring to FIG. 4, the allowed exemplary, non-limiting parameters that determine the data and data ranges of the energy capacity and delivery agreement (ECDA) which, in turn, results in the operating parameters of the deployment and dispatch algorithm (DDA), are shown. The distribution utility company (DUC) is responsible for providing a full description, including maps, charts, tables, spreadsheet databases, and other documents, as a means of describing its total set of relevant assets. The DUC indicates at which nodes it has historically experienced problems (e.g. power capacity, congestion, voltage regulation, reliability, load growth, load variability, T&D asset quality, and others) and/or where it anticipates it will have problems in the future. These problems can be quantified by the DUC, either in absolute terms, or (preferably), in prioritized terms of strategic importance and adverse effects from the DUC perspective. This helps the owner/manager of the mobile energy generating units (NES) focus upon which areas will be the quickest and easiest to relieve, or eliminate altogether. The DUC further defines the cause-and-effect relationships between the measures previously taken, and/or hypothetically relevant, to solving the problems noted.

Together, DUC and NES strategize any combination of SCAMPS mobile energy generating unit services that could be utilized at, or near, the problem areas identified. NES and DUC run “what-if” scenarios to predict resulting measurable improvements from SCAMPS mobile energy generating units implementation regarding each unique possible solution permutation (considering all the different parameters available). The DUC further defines its plans and historical measures taken with various alternative approaches, in order to establish a baseline effect, above which SCAMPS mobile energy generating units implementation benefits would need to exceed in order to justify a) socket siting, b) module deployment to that site, or c) dispatch of that deployed module. DUC also provides financial figures that comprise the alternative solutions, such that SCAMPS mobile energy generating units can be compared on an equitable (“all-in cost”) basis to those alternatives, and evaluated within the deployment and dispatch algorithm (DDA) (“EVOC Test” step described below). Finally, DUC provides backup data to NES for any fine-tuning of the to-be-customized DDA calculations and formulas.

From the above info, NES re-defines the predictive model of where, when, under what conditions, and in what configuration the SCAMPS mobile energy generating units would be considered for deployment. Based upon this information, NES identifies the least-cost configuration and portfolio mix for the fleet of SCAMPS mobile energy generating units that will adequately satisfy the required performance at that site. In addition, NES works with DUC to define the appropriate interconnection requirements for, and the cost to construct and install, the SCAMPS data communication socket, for each node location.

Following that, DUC defines the specific set(s) of conditions under which the deployed SCAMPS mobile energy generating units are to be dispatched, and then creates a set of formulas that will calculate the critical economically viable operating condition (EVOC) variable(s) to trigger the action(s) designated energy based on the capacity and delivery agreement (ECDA) data. From this, NES composes and submits the ECDA for DUC approval. From the approved ECDA comes the parameters which ultimately feed the specifications for function of the DDA, including both Deployment and Dispatch Order generation and execution for the SCAMPS mobile energy generating units.

More specifically referring to FIG. 4, at block 401 DUC maps out entire system of existing infrastructure (all T&D and related assets). At block 403, DUC indicates nodes at which problems exist, have existed in the past, or are forecast to exist in the future. At block 405, DUC indicates system metric data ranges/averages at each mode, references historical database of past measurements and variables. At block 407, DUC describes and quantifies cause-and-effect relationships between/among system variables and non-system variables. At block 409 DUC identifies which variables are to be targeted for triggering a Deployment or Dispatch Order. At block 411 DUC defines calculations & formulas that show predicted results from target variables input, and specifies values at which each is triggered. At block 413, DUC indicates forecast data for all system and non-system variables. At block 415, DUC defines plans for network repairs, outages, maintenance, replacement, upgrades, etc. At block 417, DUC prioritizes severity of forecast problems for all network nodes, segments; including timeframes. At block 419, DUC defines total budget and cost structures for predictive financial model, including sensitivity analysis (best/worst cases). At block 421, DUC provides NES with all data and other relevant information from above analyses. At block 423, NES indicates cost for each SCAMPS socket (interconnection substation), per location. At block 425, NES analyzes effects (in all metrics) of adding incremental SCAMPS modules at each network node. At block 427, NES creates plan to product “optimal solution” for/as-defined-by DUC, in specific metrics, costs, other terms and conditions. At block 429, NES defines sensitivity parameters around actual variations from plan (e.g. operating for additional energy sales to IND, ISO). At block 431, NES composes ECDA to DUC with specific terms and conditions input from above analysis. At block 433, based upon ECDA terms, NES and/or DUC installs SCAMPS “sockets” and ensures availability of local Base Camp Site.

5. Energy Capacity and Delivery Agreement Data (ECDA)

The functioning parameters of the Energy and Capacity Delivery Agreement (ECDA) prepared by the distribution utility company (DUC) and the provider of the system and method of the subject invention (NES) establishes the operating ranges, based on internal and external data, for the activation and use of the SCAMPS mobile energy generating units by the deployment and dispatch algorithm (DDA) by the DDA's implementation of the total cost of delivered power (TCDP) calculator software module in order to asses whether an economically viable operating condition (EVOC) exists (when the total cost of delivered power (or other services such as voltage regulation or support, non-spinning or spinning reserve, or available capacity) by implementation of one or more of the SCAMPS mobile energy generating units is less than the total cost of delivered power using alternative means) to then implement (initially deploy or dispatch) one or more SCAMPS mobile energy generating units.

These ECDA function parameters accessed by the deployment and dispatch algorithm (DDA) to facilitate the total cost of delivered power (TCDP) subroutine are shown, as non-limiting examples of the types of data and outer ranges that can be employed, in Table 1 through 5.

TABLE 1
EDCA General Terms

| | |
|---|---|
| A. | ECDA Start Date/Time: , , 20 , at a.m./p.m. |
| B. | ECDA Finish Date/Time: , , 20 , at a.m./p.m. |
| C. | Total SCAMPS MW under contract: MW (at maximum |
| | fleet size) |
| D. | Total SCAMPS Capacity Days (Hours) under contract: Days |
| | (Hours) |
| E. | Total SCAMPS-Sockets under contract: Sites |
| F. | DUC Headquarters Location: |
| G. | DUC Liaison Contact Information: |
| H. | DUC Home Base Camp (HBC) Location: |

TABLE 2
SCAMPS-Socket Site Selection and Implementation
Table 2A: SCAMPS-Socket Logistics Schedule

| | | Exact Node | Max. Power | | | Site | Distance |
|---|---|---|---|---|---|---|---|
| Socket | | Location on | Capacity | Connection | Site Installation | Modification | from Home |
| Number | Socket Address | Grid | (MW) | Line Voltage | Requirements | Requirements | Base Camp |
| Units, | “101 Main St. | GPS | 500 kW to 80 MW, | 400 V to 15 kV, | “lease | “tree | “17 miles, |
| value | Parking Lot” | coordinates; | typically | typically | agreement”; | clearing”; | by surface |
| ranges, | | “100 ft. So. | | | “amended | “pavement”; | road” |
| and/or | | of substation | | | permit” | “security | |
| example: | | #50031” | | | | fencing” | |
| 000 | (HBC) | | | | | | 0 |
| 001 | | | | | | | |
| 002 | | | | | | | |
| 003 | | | | | | | |
| 004 | | | | | | | |
| 005 | | | | | | | |
| 006 | | | | | | | |
| 007 | | | | | | | |
| 008 | | | | | | | |
| 010 | | | | | | | |
| 011 | | | | | | | |
| 012 | | | | | | | |

Table 2B: SCAMPS-Socket/Node Attributes

| Socket | Property | Abutting Property | Proximity to | Fuel | Fuel Storage | Fuel Source | Proximity to |
|---|---|---|---|---|---|---|---|
| Number | Zone Type | Zoned | Fuel Source | Source(s) | Capacity | Modif'n Reqts. | Rail |
| Units, | Commercial, | (same as previous) | (Miles, Ft.) | Propane, | 1,000 gal. to | “new Ngas extns., | “1.5 mi.” |
| value | Hvy Indust., | | | NGas, No. | 500 k gal. | meter”; “install | |
| ranges, | Lgt Indust., | | | 2 Fuel Oil | | UG tank; “install | |
| and/or | Utility | | | | | filling station spill | |
| example | Agricultural | | | | | cont.” | |
| 001 | | | | | | | |
| 002 | | | | | | | |
| 003 | | | | | | | |
| 004 | | | | | | | |
| 005 | | | | | | | |
| 006 | | | | | | | |
| 007 | | | | | | | |
| 008 | | | | | | | |
| 010 | | | | | | | |
| 011 | | | | | | | |
| 012 | | | | | | | |

Table 2C: Load and Performance for SCAMPS-Socket/Nodes (Local-Host Site)

| Socket | Maximum | Average | Minimum | Load Std. | Load Cycle | Voltage | Heat/Steam |
|---|---|---|---|---|---|---|---|
| Number | Load | Load | Load | Deviation | Frequency | Variability | Consumption |
| Units, | (MW) | same | same | same | e.g. (minutes | +/− Volts | (mm Btu/hr.) |
| value | | | | | to hours, | | |
| ranges, | | | | | from max. to | | |
| and/or | | | | | min.) | | |
| example: | | | | | | | |
| 001 | | | | | | | |
| 002 | | | | | | | |
| 003 | | | | | | | |
| 004 | | | | | | | |
| 005 | | | | | | | |
| 006 | | | | | | | |
| 007 | | | | | | | |
| 008 | | | | | | | |
| 010 | | | | | | | |
| 011 | | | | | | | |
| 012 | | | | | | | |

Table 2D: SCAMPS-Services Desired per Socket/Site

| Socket | | | Voltage | Voltage | Spinning | Non-Spinning | Waste | |
|---|---|---|---|---|---|---|---|---|
| Number | Capacity | Energy | Regulation | Support | Reserve | Reserve | Heat | Other |
| Units, | (e.g. 500 kW | (MW) | Reactive Var | Var to kVar | MW | MW | (mm | |
| value | to 50 MW) | | or kVar, as | | | | Btu/hr) | |
| ranges, | | | needed in | | | | | |
| and/or | | | real-time | | | | | |
| example: | | | | | | | | |
| 001 | | | | | | | | |
| 002 | | | | | | | | |
| 003 | | | | | | | | |
| 004 | | | | | | | | |
| 005 | | | | | | | | |
| 006 | | | | | | | | |
| 007 | | | | | | | | |
| 008 | | | | | | | | |
| 010 | | | | | | | | |
| 011 | | | | | | | | |
| 012 | | | | | | | | |

Table 2E: SCAMPS-Socket Installation Schedule

| Socket | Installation | Installation | Permit | Maintenance | Installation | Installation | |
|---|---|---|---|---|---|---|---|
| Number | In-Svc Date | Project Time | Reqmts. | Reqmts. | Resource(s) | Total Cost | Other |
| Units, | (DD/MM/YY | (e.g. 30 days) | (e.g. DEC | (e.g. | (e.g. contract | ($x.00) | |
| value | YY:00:00) | | air permits; | engineering, | construction | | |
| ranges, | | | tank permits; | inspection, | vendor(s)) | | |
| and/or | | | building | testing) | | | |
| example: | | | permits) | | | | |
| 001 | | | | | | | |
| 002 | | | | | | | |
| 003 | | | | | | | |
| 004 | | | | | | | |
| 005 | | | | | | | |
| 006 | | | | | | | |
| 007 | | | | | | | |
| 008 | | | | | | | |
| 010 | | | | | | | |
| 011 | | | | | | | |
| 012 | | | | | | | |

TABLE 3
SCAMPS-Module Fleet Portfolio
SCAMPS-Module Initial Fleet Mix

| Module | | | Synchronous | | | Number of | Additional |
|---|---|---|---|---|---|---|---|
| Type | Module Size | Prime Mover | Condensing | Fuel | | Modules on | Equipment |
| Code | (MW) | Type | Capability | Type(s) | Heat Rate | Reserve | Required |
| Units, | (MW) | (e.g. | (e.g. presence | (Propane, | (Btu/kW- | (e.g. 1 to | (e.g. SCRs, |
| value | | reciprocating | of generator | NGas, | hr) | 150) | exhaust stack |
| ranges, | | engine, | clutch and | LSDF, etc.) | | | extensions; |
| and/or | | turbine) | related | | | | add'l sound |
| example: | | | equipment) | | | | attenuation) |
| 001 | | | | | | | |
| 002 | | | | | | | |
| 003 | | | | | | | |
| 004 | | | | | | | |
| 005 | | | | | | | |
| 006 | | | | | | | |
| 007 | | | | | | | |
| 008 | | | | | | | |
| 010 | | | | | | | |
| 011 | | | | | | | |
| 012 | | | | | | | |

TABLE 4
SCAMPS-Module Deployment Plan
SCAMPS-Module Initial (from Home Base Camp) Deployment Plan

| | Initially | Deploy Order | Deploy Order | Auto-Deploy | Auto-Deploy | Auto-Deploy |
|---|---|---|---|---|---|---|
| ModuleType | Deployed to | Start | Finish | Trigger | Trigger | Trigger |
| Code | Socket No. | Date/Event | Date/Event | Event(s) | Value(s) | Response(s) |
| Units, | (e.g. NY- | (per ECDA) | (same) | (e.g. Dept. of | (e.g. Terrorism | DDA issues |
| value | SUFCTY- | | | Homeland | Warning = “High”) | Deploy |
| ranges, | 0010) | | | Security issues | | Order; HBC |
| and/or | | | | Terrorism | | sends module |
| example: | | | | Warning) | | to Socket #x) |
| 001 | | | | | | |
| 002 | | | | | | |
| 003 | | | | | | |
| 004 | | | | | | |
| 005 | | | | | | |
| 006 | | | | | | |
| 007 | | | | | | |
| 008 | | | | | | |
| 010 | | | | | | |
| 011 | | | | | | |
| 012 | | | | | | |

TABLE 5
SCAMPS-Module Dispatch Plan
SCAMPS-Module Automated Activity Parameters

| | | Dispatch | |
|---|---|---|---|
| Socket | Dispatch Trigger | Trigger | Dispatch Trigger |
| Number | Event(s) | Value(s) | Response(s) |
| Units, | (e.g. TCDPs < | MCDP <= $.10/kW) | “DDA executes |
| value | TCDPa; each | | Dispatch Order; |
| ranges, | summer day from | | module engine |
| and/or | 12:00 to 18:00 | | started; AGC |
| example: | | | assumes control” |
| 001 | | | |
| 002 | | | |
| 003 | | | |
| 004 | | | |
| 005 | | | |
| 006 | | | |
| 007 | | | |
| 008 | | | |
| 010 | | | |
| 011 | | | |
| 012 | | | |

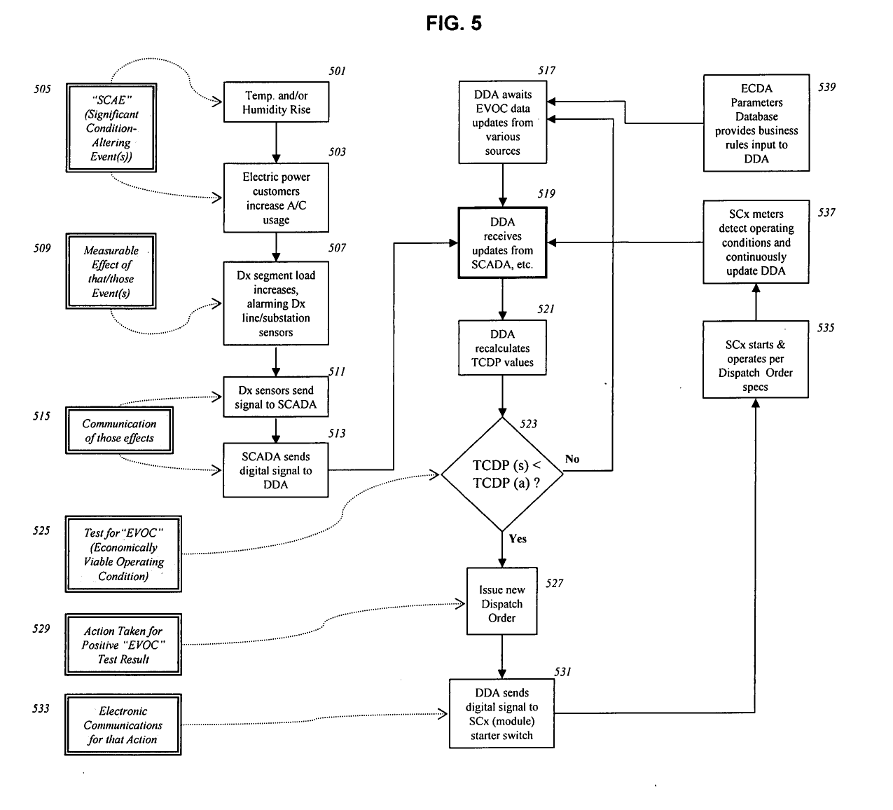

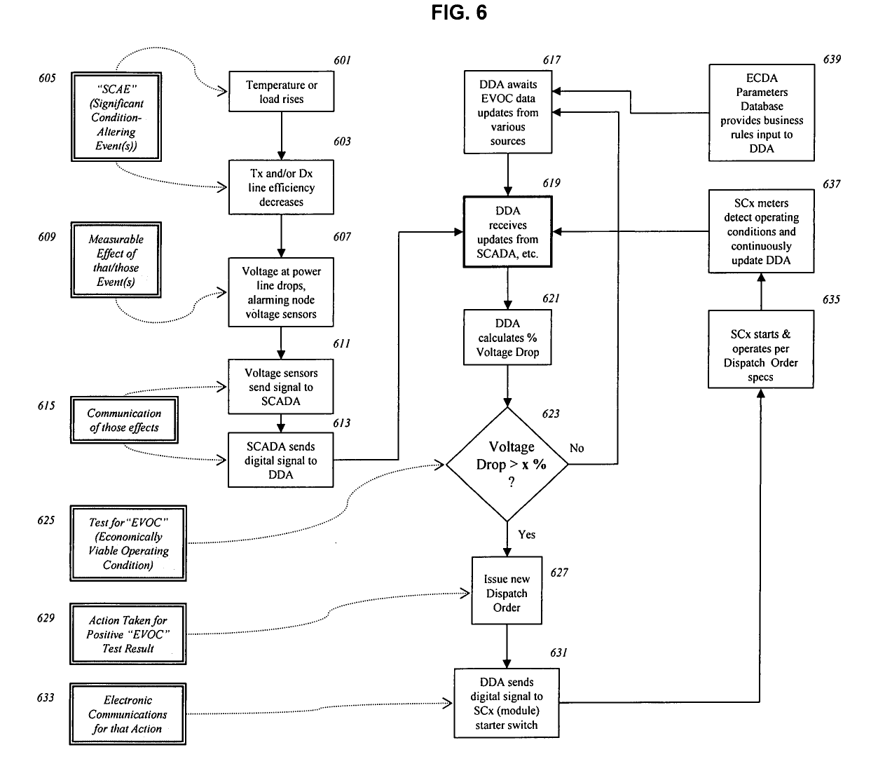

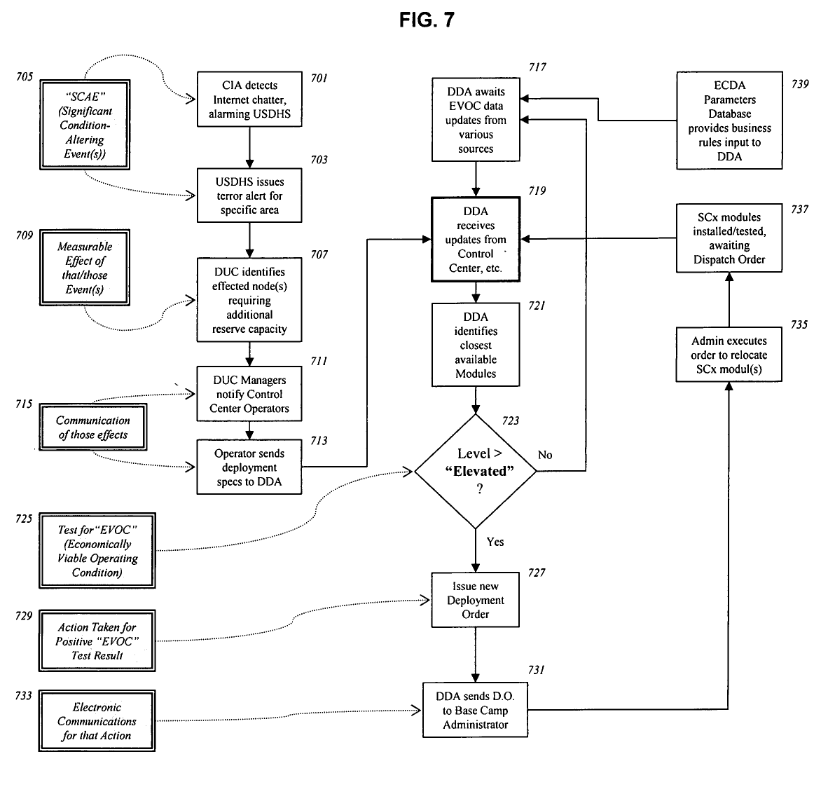

The above tables of energy capacity and delivery agreement data and data ranges (105 of FIG. 1, 539 of FIG. 5, 639 of FIG. 6 and 739 of FIG. 7) are accessed by the deployment and dispatch algorithm (DDA) (107 of FIG. 1, 521 of FIG. 5, 621 of FIG. 6 and 721 of FIG. 7) in order for the total cost of delivered power (TCDP) calculator software module to calculate whether an economically viable operating condition (EVOC) for one or more SCAMPS mobile energy generating units has occurred, as discussed in further detail below.

6. Mobile Unit Triggering Process (The DDA)

Referencing FIGS. 1, 5, 6 and 7, the deployment and dispatch algorithm (DDA) is programmed with the above described set of default conditions as provided by the Energy Capacity and Delivery Agreement (ECDA) 105, under which the SCAMPS mobile energy generating units has been deployed, in anticipation of the need, and under which parameters for them to generate. The DDA's Total Cost of Delivered Power (TCDP) Calculator is a separate software module discussed in detail below, whose specific calculations, formulas, business rules, and other attributes are determined by and through the Energy Capacity and Delivery Agreement (ECDA) 105. These conditions will have been previously determined by both the DUC and NES, and their appropriate values and attributes input into the TCDP Calculator software module. The conditions are a function of any number of variables as exemplified above in discussion of the ECDA data, values and ranges which are characteristic of that DUC and its business operating environment.

The TCDP Calculator software module is responsible for evaluating the relative costs to deliver the next kW-hr of electricity to a specified node within the DUC's grid. The costs evaluated to calculate the total cost of delivered power (TCDP) are those that would be associated with that delivery taking place via SCAMPS mobile energy generating units (TCDPs) versus that delivery taking place via the DUC's other best alternative method (TCDPa). Three basic conditions can therefore exist:

A. TCDPₛ>TCDPₐ, in which case power is delivered through the alternate (default) process.

B. TCDPₛ=TCDPₐ, in which case power delivery process will transition from one to the other.

C. TCDPₛ<TCDPₐ, in which case power is delivered through SCAMPS mobile energy generating units.

Condition (C.), above, is referred to as the EVOC (“economically viable operating conditions”) for SCAMPS mobile energy generating units, and is that set of conditions which, when met or exceeded, would trigger the deployment and dispatch algorithm (DDA) to issue and/or execute its Dispatch Order to the SCAMPS mobile energy generating units (SCx in FIGS. 5, 6 and 7) in question. Therefore, each deployed SCAMPS mobile energy generating unit will have a unique economically viable operating conditions (EVOC) set during its deployment; any re-deployment would require that a new EVOC set be established, and that the TCDP Calculator employed by the deployment and dispatch algorithm (DDA) be updated with any and all revised values.

The EVOC condition can occur as a result of a change in any one or more of the ECDA variables. Any event which leads to the change in current operating conditions (i.e. such that the operating condition above changes from either A., B., or C. to another), is referred to as a “significant condition-altering event” (SCAE). In one example, changes in a combination of outside temperature and/or humidity are such that it causes a significant number of the DUC power customers to turn on their air conditioning equipment (A/C). Prior to the rise in Temp/Humidity, Dx load was such that total system (T&D) congestion was low, which was reflected in a low Tx congestion charge imposed upon the DUC. As a component of TCDP(a), the earlier set of variables resulted in operating condition (A.), above, and power was being delivered via the DUC's best alternative process (e.g. stationary power plant, over T&D lines). The aggregate consumer reaction to this SCAE, however, causes a significant increase in load on that segment of the Dx system, which encompasses the deployed SCAMPS mobile energy generating unit in question. The load increase is detected by the supervisory control and data acquisition (SCADA) system, signaled to the deployment and dispatch (DDA), whose recalculation of total cost of delivered power (TCDP) employing the TCDP calculator subroutine results in the operating condition changing from (A.) to (C.), triggering the issuance of a Dispatch Order, whose details are digitally delivered to the automatic controller equipment on the SCAMPS mobile energy generating unit starter, initiating power generation.

Specifically referring to FIG. 5, the DDA software logic is next described for the embodiment pertaining to base load or peaking power. Block 501 denotes a change in a 30. physical condition, in this case an increase in the temperature or humidity in the geographic area of interest (i.e., the geographic are serviced by the portion of the energy grid supported by the SCAMPS mobile energy generating unit of this illustrative example).

Block 503 denotes the causal effect of the increase in temperature or humidity of block 501, more specifically an increase in electric power usage in the geographic area of interest due to an increase in the use of air conditioners and fans. Element 505 is a descriptor, not a logic element, which defines the actions of block 501 and block 503 as examples of significant condition altering events (SCAE). At block 507 the line and substation sensors are triggered when the segment load (Dx) has increased above a predetermined level. Element 509 defines the actions of block 507 as a measurable effect of the significant condition altering events defined in element 505 and described in blocks 501 and 503. At block 511 the sensors, having been triggered, send a notification signal to supervisory control and data acquisition systems (SCADA), and at block 513 the supervisory control and data acquisition systems transmit this notification signal to the deployment and dispatch algorithm (DDA). The actions of block 511 and 513 are defined, at element 515, as communication of the measurable effect of element 509. As shown at block 517, the deployment and dispatch algorithm is in a receptive “wait” mode wherein it can receive data updates pertaining to economically viable operating conditions (EVOC) that will trigger the execution of a dispatch order, as further described below. Next referring to block 519, the deployment and dispatch algorithm receives the notification signal transmitted by the supervisory control and data acquisition system at block 513. At block 521, the deployment and dispatch algorithm recalculates the total cost of delivered power (TCDP). At block 523, a decision block, the deployment and dispatch algorithm determines if the total cost of delivered power employing the SCAMPS mobile energy generating unit (TCDP(s)) is less than the total cost of delivered power employing predefined other alternative sources or processes (TCDP(a)), which is defined, at element 525 as the test for the presence or absence of an economically viable operating condition (EVOC). If the answer at decision block 523 is “no” (TCDP(s) is not less than TCDP(a)), then, at block 517, previously described, the deployment and dispatch algorithm remains in its receptive “wait” mode for receipt of data updates pertaining to economically viable operating conditions that will trigger the execution of a dispatch order. If, on the other hand, the answer at decision block 523 is “yes”, (TCDP(s) is less than TCDP(a)), then a new dispatch order is issued by the deployment and dispatch algorithm at block 527, which is defined at element 529 as the action taken for a positive economically viable operating condition test. Next, at block 531 the deployment and dispatch algorithm transmits a START command to the starter control circuit of the SCAMPS mobile energy generating unit (defined at element 533 as electronic communication for the action of element 529).

At block 535, the SCAMPS mobile energy generating unit starts and operates in accordance with the specifications of the dispatch order from the deployment and dispatch algorithm. At block 537, the internal sensors of the SCAMPS mobile energy generating unit detect and monitor the unit's operating conditions and, at block 519, continually provides this data in substantially real time to the deployment and dispatch algorithm.

Specifically referring to FIG. 6, the DDA software logic is next described for the embodiment pertaining to voltage support. Block 601 denotes a change in a physical condition, in this case an increase in the temperature or load in the geographic area of interest (i.e., the geographic are serviced by the portion of the energy grid supported by the SCAMPS mobile energy generating unit of this illustrative example).

Block 603 denotes the causal effect of the increase in temperature or load of block 601, more specifically a decrease in Tx and/or Dx line efficiency. Element 605 is a descriptor, not a logic element, which defines the actions of block 601 and block 603 as examples of significant condition altering events (SCAE). At block 607 the line and substation sensors are triggered when the voltage at the power line drops below a predetermined level. Element 609 defines the actions of block 607 as a measurable effect of the significant condition altering events defined in element 605 and described in blocks 601 and 603. At block 611 the voltage sensors, having been triggered, send a notification signal to supervisory control and data acquisition systems (SCADA), and at block 613 the supervisory control and data acquisition systems transmit this notification signal to the deployment and dispatch algorithm (DDA). The actions of block 611 and 613 are defined, at element 615, as communication of the measurable effect of element 609. As shown at block 617, the deployment and dispatch algorithm is in a receptive “wait” mode wherein it can receive data updates pertaining to economically viable operating conditions (EVOC) that will trigger the execution of a dispatch order, as further described below. Next referring to block 619, the deployment and dispatch algorithm receives the notification signal transmitted by the supervisory control and data acquisition system at block 613. At block 621, the deployment and dispatch algorithm calculates the percent voltage drop. At block 623, a decision block, the deployment and dispatch algorithm determines if the percent voltage drop is less than a predetermined percent voltage drip as defined in the ECPA, which is defined, at element 625 as the test for the presence or absence of an economically viable operating condition (EVOC). If the answer at decision block 623 is “no”, then, at block 617, previously described, the deployment and dispatch algorithm remains in its receptive “wait” mode for receipt of data updates pertaining to economically viable operating conditions that will trigger the execution of a dispatch order. If, on the other hand, the answer at decision block 623 is “yes”, then a new dispatch order is issued by the deployment and dispatch algorithm at block 627, which is defined at element 629 as the action taken for a positive economically viable operating condition test. Next, at block 631 the deployment and dispatch algorithm transmits a START command to the starter control circuit of the SCAMPS mobile energy generating unit (defined at element 633 as electronic communication for the action of element 629).

At block 635, the SCAMPS mobile energy generating unit starts and operates in accordance with the specifications of the dispatch order from the deployment and dispatch algorithm. At block 637, the internal sensors of the SCAMPS mobile energy generating unit detect and monitor the unit's operating conditions and, at block 619, continually provides this data in substantially real time to the deployment and dispatch algorithm.

Specifically referring to FIG. 7, the DDA software logic is next described for the embodiment pertaining to terrorism risk management. Block 701 denotes a change in a physical condition, in this case an increase in terrorist-based Internet chatter detected by the CIA related to in the geographic area of interest (i.e., the geographic are serviced by the portion of the energy grid supported by the SCAMPS mobile energy generating unit of this illustrative example). The CIA then notifies the United States Department of Homeland Security.

Block 703 denotes the causal effect of the CIA intelligence of block 701, more specifically an increase in the terrorism alert level by the United States Department of Homeland Security. Element 705 is a descriptor, not a logic element, which defines the actions of block 701 and block 703 as examples of significant condition altering events (SCAE). At block 707 the DUC identifies nodes requiring increased capacity. Element 709 defines the actions of block 707 as a measurable effect of the significant condition altering events defined in element 705 and described in blocks 701 and 703. At block 711 the DUC notifies the control center operators, and at block 713 the operators send deployment specifications to the deployment and dispatch algorithm (DDA). The actions of block 711 and 713 are defined, at element 715, as communication of the measurable effect of element 709. As shown at block 717, the deployment and dispatch algorithm is in a receptive “wait” mode wherein it can receive data updates pertaining to economically viable operating conditions (EVOC) that will trigger the execution of a dispatch order, as further described below. Next referring to block 719, the deployment and dispatch algorithm receives the notification signal transmitted by the operator at block 713. At block 721, the deployment and dispatch algorithm calculates whether the terrorism alert level (for example, as provided by the United States Department of Homeland Security) has increased from its prior level. At block 723, a decision block, the deployment and dispatch algorithm determines if the terrorism alert level has, in fact, been raised (and optionally, whether is has been raised to or above a predetermined threshold level), which is defined, at element 725 as the test for the presence or absence of an economically viable operating condition (EVOC). If the answer at decision block 723 is “no”, then, at block 717, previously described, the deployment and dispatch algorithm remains in its receptive “wait” mode for receipt of data updates pertaining to economically viable operating conditions that will trigger the execution of a dispatch order. If, on the other hand, the answer at decision block 723 is “yes”, then a new dispatch order is issued by the deployment and dispatch algorithm at block 727, which is defined at element 729 as the action taken for a positive economically viable operating condition test. Next, at block 731 the deployment and dispatch algorithm transmits the dispatch order to the base camp administrator (defined at element 733 as electronic communication for the action of element 729).

At block 735, the base camp administrator orders relocation of certain SCAMPS mobile energy generating units in accordance with the specifications of the dispatch order from the deployment and dispatch algorithm. At block 737, the SCAMPS mobile energy generating units are relocated and tested, and, at block 719, continually provides this data in substantially real time to the deployment and dispatch algorithm.

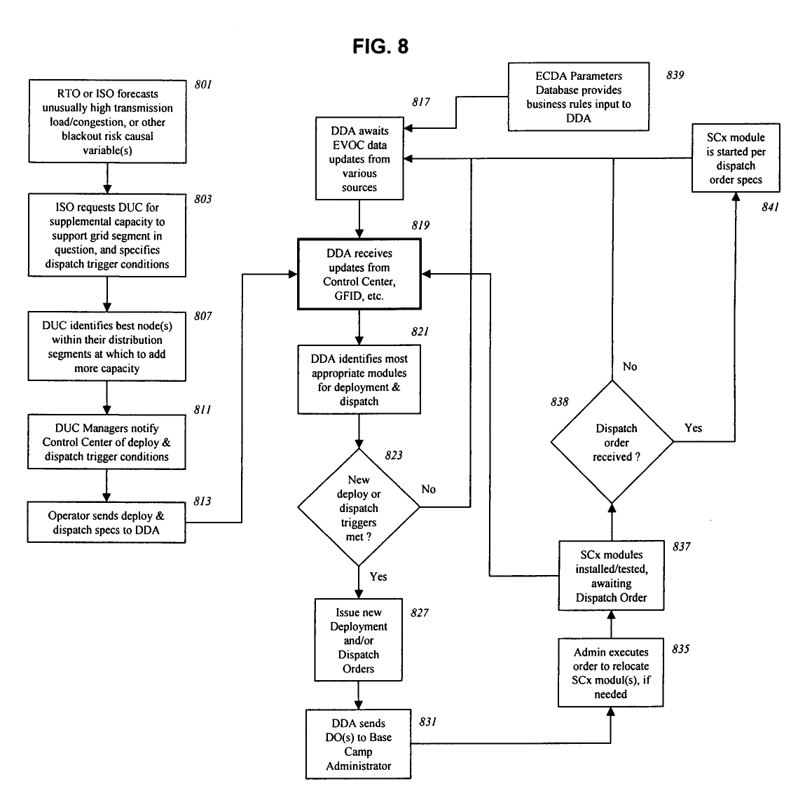

Specifically referring to FIG. 8, the DDA software logic is next described for the embodiment pertaining to blackout prevention and system failure risk management. Block 801 denotes a change in a physical condition, in this case an increase in transmission system congestion and/or blackout risk causal variables related to in the geographic area of interest (i.e., the geographic are serviced by the portion of the energy grid supported by the SCAMPS mobile energy generating unit of this illustrative example). The transmission system operator then notifies the ISO or other system operator who in turn notifies the DUC.

Block 803 denotes the causal effect of the transmission system intelligence of block 801, more specifically an increase in the criticality of transmission system congestion and/or other blackout-causing conditions. At block 807 the DUC identifies nodes requiring increased capacity. At block 811 the DUC notifies the control center operators, and at block 813 the operators send deployment and dispatch specifications to the deployment and dispatch algorithm (DDA). As shown at block 817, the deployment and dispatch algorithm is in a receptive “wait” mode wherein it can receive data updates pertaining to ISO or DUC Management orders that will trigger the execution of a deployment and/or dispatch order, as further described below. Next referring to block 819, the deployment and dispatch algorithm receives the notification signal transmitted by the operator at block 813. At block 821, the deployment and dispatch algorithm identifies which specific modules are the most appropriate for deployment, and potential dispatch, from those listed as available within the GFID. At block 823, a decision block, the DDA determines if the criticality of transmission system congestion and/or other blackout cause variables have, in fact, been met. If the answer at decision block 823 is “no”, then, at block 817, previously described, the DDA remains in its receptive “wait” mode for receipt of data updates pertaining to ISO or DUC Management orders that will trigger the execution of a dispatch order. If, on the other hand, the answer at decision block 823 is “yes”, then a new deployment and/or dispatch order is issued by the DDA at block 827. Next, at block 831 the DDA transmits the deployment and/or dispatch order to the base camp administrator.

At block 835, the base camp administrator orders relocation of certain SCAMPS mobile energy generating units in accordance with the specifications of any new or revised deployment order from the DDA. At block 837, the SCAMPS mobile energy generating units are relocated, if necessary, and tested, and, at block 819, continually provides this data in substantially real time to the deployment and dispatch algorithm.

Once the mobile energy generating units are relocated, the DDA can, as shown at block 838, then execute an existing, or newly-issued, dispatch order to initiate operation of the deployed module(s), as shown in block 841, which is inputted into block 817, previously described. Also inputted to block 817, the ECDA parameters database provides business rules input at block 839.

A similar protocol is employed for the initial deployment of the SCAMPS mobile energy generating units. However, the decision to deploy will be made more in an “off-line” mode rather than in an automated, computer-driven fashion. Deployment of a particular SCAMPS mobile energy generating unit to a specific node in the energy grid will be determined based more upon the anticipation of a possible future condition (or set thereof). Typically, deployment will be executed by order of a DUC manager, significantly ahead of time from the point at which dispatch would be required, and driven by a highly subjective assessment of risk, as well as by hard data from computed calculations within the deployment and dispatch algorithm (DDA). The deployment and dispatch algorithm (DDA) is utilized to run “what-if scenarios” by DUC analysts or operators, as a means of facilitating the DUC manager's decision.

As mentioned above, each deployed SCAMPS mobile energy generating unit will have a unique economically viable operating condition (EVOC) set facilitating its specific Deployment Order by the deployment and dispatch algorithm (DDA). Correspondingly, any re-deployment would require that a new economically viable operating conditions (EVOC) set be established, and the TCDP Calculator software module employed by the deployment and dispatch algorithm (DDA) be updated with that new condition, or set of conditions. The energy capacity and delivery agreement (ECDA) will determine which SCAMPS mobile energy generating unit services (see Table 6 for non-limiting examples) will be offered, and under what conditions each will be delivered. The need for, and existence of, different SCAMPS mobile energy generating unit services will likely influence the DUC decision not only to dispatch modules, but also to deploy modules (see Table 7 for non-limiting examples).

TABLE 6
SCAMPS Services and Dispatch-Triggering Events

| | Dispatch Execution | Typical Dispatch- |
|---|---|---|
| SCAMPS Service | Condition | Triggering Event(s) |
| Base Load or Peaking | TCDPₛ < TCDPₐ | Load Spike; |
| Power | | Heat Wave |
| Voltage Regulation | Voltage σ > ( | |
| Voltage Support | Voltage loss > (% | |
| Spinning Reserve | Voltage drop rate > (V/sec. | |
| Non-Spinning Reserve | Voltage drop rate > (V/sec. | |
| Power Factor | ??? | |
| Correction | | |
| Emergency Backup | Power = 0 kW | |
| Power | | |
| Black Start | Ready to restart shut-down | |
| | plant | |
| Terrorism Risk | Risk > “Elevated” | |
| Management | | |

TABLE 7
SCAMPS Services and Deployment Initiating
Conditions or Events

| | | Typical |
|---|---|---|
| | Deployment Execution | Deployment- |
| SCAMPS Service | Condition | Triggering Event(s) |
| Base Load or Peaking | TCDPₛ < TCDPₐ | Weather forecast; |
| Power | | Load growth |
| Voltage Regulation | Voltage σ > ( | Historical |
| | | Problems |
| Voltage Support | Voltage loss > (% | |
| Spinning Reserve | Voltage drop rate > (V/sec. | |
| Non-Spinning Reserve | Voltage drop rate > (V/sec. | |
| Power Factor | | |
| Correction | | |
| Emergency Backup | Voltage = 0 V | |
| Power | | |
| Black Start | Outage has occurred | |
| Terrorism Risk | Terr. Threat Level > | CIA/DHS Rept.; |
| Management | “Elevated” | Monitored Chatter |

7. Total Cost of Delivered Power Software (The TCDP Calculator)

Referring again to FIGS. 1, 5, 6 and 7 the functioning of the total cost of delivered power (TCDP) calculator software module accessed by the deployment and dispatch algorithm (DDA) (107 of FIG. 1, 521 of FIG. 5, 621 of FIG. 6 and 721 of FIG. 7) is specifically described. The TCDP or total cost of delivered power (or other related service) is calculated from a set of variables comprised of the following. First, third-party variables and there sources that serve as inputs to the TCDP calculation are usually obtained from electricity markets and/or electric utilities/distribution utility companies such as described below in Table 8:

TABLE 8

| Variable | Source |
|---|---|
| Cost of energy | Market such as NYISO or as |
| | calculated by DUC |
| Cost of capacity | Market such as NYISO or as |
| | calculated/negotiated by DUC |
| Cost of ancillary services | Market such as NYISO or as |
| | calculated/negotiated by DUC |
| Voltage support | |
| Voltage regulation | |
| Spinning reserve | |
| Non-spinning reserve | |
| Congestion charges | Market such as NYISO |
| Cost of losses | Market such as NYISO |
| Fuel | Market or as negotiated with |
| | nominated supplier or utility co. |

Second, based on the siting criteria and other variables determined by the DUC and NES, the nodes, or locations, for which the TCDP is calculated are determined along with the location specific costs that serve as an input to the TCDP calculations.

Third, calculated variables are generally calculated based on location specific criteria, examples of which are provided in Table 9:

TABLE 9

Capital cost amortization for both SCAMPS equipment and
for the DUC's best alternative
Interest costs
Fixed maintenance costs for both SCAMPS equipment and for
the DUC's best alternative
Variable maintenance costs for both SCAMPS equipment and
for the DUC's best alternative
Fuel costs per unit of power (or other related service) for both
SCAMPS equipment and for the DUC's best alternative

These variables, as applicable to a particular deployment, are fed into a series of equations (described below) that produce the TCDP

The resulting “TCDP” is then used to trigger certain dispatch actions such as: Start/Stop; Enable/Disable spinning reserve; Enable/Disable non-spinning reserve; Enable/Disable voltage regulation; and Enable/Disable AGC (Automatic generator control).

Based on, for example, the variables provided above, the total cost of delivered power (or other related service) is calculated for the comparison base (TCDPa). This represents the comparative value against which the calculated value for the SCAMPS mobile energy generating unit (TCDPs) is measured in order to determine the use of SCAMPS mobile energy generating unit at a particular node or location. This is the DUC's cost for the best alternative to SCAMPS mobile energy generating units:

TCDPₐ=

+Energy cost i.e., fuel, maintenance and amortization of capital cost {As a function of market pricing and/or Capital costs for generating equipment (construction costs, interest costs, depreciation, etc.), Operation & maintenance costs (fixed & variable as applicable), fuel costs, plant efficiency, etc.}

+Capacity cost i.e., interest costs and fixed maintenance cost {As a function of market pricing and/or Capital costs for generating equipment (construction costs, interest costs, depreciation, etc.), Operation & maintenance costs (fixed & variable as applicable), fuel costs, plant efficiency, etc.}

+Ancillary services cost i.e., cost of reactive power {As a function of location based variables i.e., congestion and power factor}

+Transmission system capital cost i.e., transmission lines {As a function of location based variables i.e., existing load}

+Distribution system capital cost i.e., transformer or substation {As a function of location based variables i.e., existing load}

+Transmission service cost i.e., maintenance {As a function of location based variables i.e., system load}

+Congestion charges i.e., market cost based on system loading {As a function of location based variables i.e., system load}

+Transmission enhancement cost i.e., cost of line extension for new load {As a function of location based variables i.e., predicted load}

+Distribution enhancement cost i.e., new transformer or substation {As a function of location based variables i.e., predicated load}

+Allocated Overhead

+DUC specific criteria i.e., amortization of existing long term contract costs.

+All calculated as a function of date, time, and node location

Next the total cost of delivered power (or other related service) (TCDPs) is calculated for SCAMPS mobile energy generating unit, this represents the cost for power (or other type of energy or service) available from a SCAMPS mobile energy generating unit at the same location as the comparison base calculated above:

TCDPₛ=

+Fuel cost i.e., cost of unit's energy source

+Fixed maintenance cost i.e., cost to maintain units

+Variable maintenance cost i.e., cost of operation of units

+Capital cost {As a function of capital costs for generating equipment (construction costs, interest costs, depreciation, etc.)}

+Socket enabling cost i.e., cost of enabling a node of the grid to accept a unit {As a function of location based variables}

+Management costs i.e., cost of licensing software

+Allocated overhead

+DUC specific criteria

+All calculated as a function of date, time, and node location

As described above, when TCDPs is less than TCDPa, one or more SCAMPS mobile energy generating units are utilized.

A schedule of TCDPa vs. TCDPs for all hours and all days for each specific node is then calculated thereby producing a dispatch schedule for the SCAMPS mobile energy generating units at defined node locations. This schedule is then altered as required throughout the year by the deployment and dispatch algorithm (DDA) based on the economically viable operating conditions (EVOC) principal.

It will be apparent to those skilled in the art that a number of changes, modifications, or alterations to the present invention as described herein may be made, none of which depart from the spirit of the present invention. All such changes, modifications, and alterations should therefore be seen as within the scope of the present invention.

We claim:

1. A system for the allocation of energy services within an energy grid comprising:
a. a plurality of mobile, selectively actuable energy generating units each connected to the energy grid;
b. a database populated with operating condition variables for each of the mobile energy generating units, actuation of each of the energy generating units based on the operating condition variables;
c. data inputs for receiving actual operating conditions associated with each of the energy generating units; and
d. a processor for analyzing the actual operating conditions and the operating condition variables to actuate at least one of the energy generating units when the actual operating conditions have a predetermined value as provided by the operating condition variables.

2. The system of claim 1 wherein each of the plurality of mobile energy generating units is connected to the energy grid at a first location, has a first actuation time for a first time duration, and produces a first energy amount wherein the processor analyzes modifications to the operating condition variables in the database to provide at least one of a second location, second actuation time for a second time duration and a second energy amount for the mobile energy generating units.

3. The system of claim 1 wherein the operating condition variables are selected from the group consisting of air temperature, air humidity, power outage, energy load growth, partial grid shut-down, voltage change and emergency power back-up.

4. The system of claim 1 wherein each of the mobile energy generating units has an operation cost based on predetermined factors, at least one alternative energy generating source has an operation cost also based on the predetermined factors, the processor calculating the operation cost for at least one mobile energy generating unit and for the at least one alternative energy generating source, the processor only actuating the at least one energy generating unit when its operating cost is less than the operating cost of the at least one alternative energy source.

5. A method for the allocation of energy services within an energy grid comprising:
a. providing a plurality of mobile, selectively actuatable energy generating units each connected to the energy grid;
b. providing a database populated with operating condition variables for each of the mobile energy generating units, actuation of each of the energy generating units based on the operating condition variables;
c. data inputs for receiving actual operating conditions associated with each of the energy generating units; and
d. a processor for analyzing the actual operating conditions and the operating condition variables to actuate at least one of the energy generating units when the actual operating conditions have a predetermined value as provided by the operating condition variables.

6. The method of claim 5 wherein each of the plurality of mobile energy generating units is connected to the energy grid at a first location, has a first actuation time for a first time duration, and produces a first energy amount wherein the processor analyzes modifications to the operating condition variables in the database to provide at least one of a second location, second actuation time for a second time duration and a second energy amount for the mobile energy generating units.

7. The method of claim 5 wherein the operating condition variables are selected from the group consisting of air temperature, air humidity, power outage, energy load growth, partial grid shut-down, voltage change, and emergency power back-up.

8. The method of claim 5 wherein each of the mobile energy generating units has an operation cost based on predetermined factors, at least one alternative energy generating source has an operation cost also based on the predetermined factors, the processor calculating the operation cost for at least one mobile energy generating unit and for the at least one alternative energy generating source, the processor only actuating the at least one energy generating unit when its operating cost is less than the operating cost of the at least one alternative energy source.

9. A system for the allocation of energy services within an energy grid comprising:
a. a plurality of mobile, selectively actuable energy generating units each connected to the energy grid;
b. a database populated with operating condition variables for each of the mobile energy generating units, actuation of each of the energy generating units based on the operating condition variables;
c. data inputs for receiving actual operating conditions associated with each of the energy generating units; and
d. a processor for analyzing the actual operating conditions and the operating condition variables to actuate at least one of the energy generating units when the actual operating conditions have a predetermined value as provided by the operating condition variables, wherein each of the mobile energy generating units has an operation cost based on predetermined factors, at least one alternative energy generating source has an operation cost also based on the predetermined factors, the processor calculating the operation cost for at least one mobile energy generating unit and for the at least one alternative energy generating source, the processor only actuating the at least one energy generating unit when its operating cost is less than the operating cost of the at least one alternative energy source.

10. The system of claim 9 wherein each of the plurality of mobile energy generating units is connected to the energy grid at a first location, has a first actuation time for a first time duration, and produces a first energy amount wherein the processor analyzes modifications to the operating condition variables in the database to provide at least one of a second location, second actuation time for a second time duration and a second energy amount for the mobile energy generating units.

11. The system of claim 9 wherein the operating condition variables are selected from the group consisting of air temperature, air humidity, power outage, energy load growth, partial grid shut-down, voltage change and emergency power back-up.

12. A method for the allocation of energy services within an energy grid comprising:
a. providing a plurality of mobile, selectively actuatable energy generating units each connected to the energy grid;
b. providing a database populated with operating condition variables for each of the mobile energy generating units, actuation of each of the energy generating units based on the operating condition variables;
c. data inputs for receiving actual operating conditions associated with each of the energy generating units; and
d. a processor for analyzing the actual operating conditions and the operating condition variables to actuate at least one of the energy generating units when the actual operating conditions have a predetermined value as provided by the operating condition variables, wherein each of the mobile energy generating units has an operation cost based on predetermined factors, at least one alternative energy generating source has an operation cost also based on the predetermined factors, the processor calculating the operation cost for at least one mobile energy generating unit and for the at least one alternative energy generating source, the processor only actuating the at least one energy generating unit when its operating cost is less than the operating cost of the at least one alternative energy source.

13. The method of claim 12 wherein each of the plurality of mobile energy generating units is connected to the energy grid at a first location, has a first actuation time for a first time duration, and produces a first energy amount wherein the processor analyzes modifications to the operating condition variables in the database to provide at least one of a second location, second actuation time for a second time duration and a second energy amount for the mobile energy generating units.

14. The method of claim 12 wherein the operating condition variables are selected from the group consisting of air temperature, air humidity, power outage, energy load growth, partial grid shut-down, voltage change, and emergency power back-up.
